(19) United States
(12) Patent Application Publication
(10) Pub. No.: US 2015/0049240 A1
(43) Pub. Date: Feb. 19, 2015

(54) Illumination Apparatus and Method for Generating an Illumination Field

(71) Applicant: SICK AG, Waldkirch (DE)

(72) Inventors: Florian SCHNEIDER, Waldkirch (DE); Denise BERTZ, Waldkirch (DE)

(21) Appl. No.: 14/457,138

(22) Filed: Aug. 12, 2014

(30) Foreign Application Priority Data
Aug. 14, 2013 (DE) 102013108801.5

(51) Int. Cl. F21V 8/00; H04N 5/235; G06K 7/14

(52) U.S. Cl. CPC G02B 6/0096; G06K 7/14; H04N 5/2354
USPC 348/370; 362/11; 235/454

(57) ABSTRACT

An illumination apparatus (10) for the generation of an illumination field (102) for an optoelectronic sensor (100) is provided which has at least one light source and an illumination optics, in particular having a TIR lens, in order to guide the light of the light source in the illumination field (102) in a directed manner, wherein the illumination optics (10) has a light entrance region, a light guidance region having a jacket surface and a light exit region such that the light of the light source is guided in the illumination optics from the light entrance region to the light exit region by means of total reflection at the jacket surface. In this connection the light guidance region is at least partly formed from a deformable material such that the geometry of the jacket surface can be changed by means of exertion of a force at the light guidance region.

The invention relates to an illumination apparatus and to a method for the generation of an illumination field in accordance with the preamble of claim 1 or claim 12 respectively.

Camera systems are frequently used for the inspection of objects or for the measurement of objects. In this respect images of the object are detected and are evaluated in accordance with the task by image processing methods. A further application of cameras is the reading of codes. Such camera-based code readers are increasingly taking over from the still widely used barcode scanners. Objects having the codes present thereon are recorded with the aid of an image sensor, the code regions are identified in the images and are then decoded. Camera-based code readers can easily also manage with different kinds of codes rather than one-dimensional barcodes, with the different kinds of codes being structured like a matrix code also in two dimensions and making available more information.

Such camera systems require an illumination in order to detect the objects to be inspected or to be measured and/or to detect the codes to be read independent of ambient light or extraneous light. Frequently LEDs are used in this respect as light sources. In comparison to the sometimes likewise used laser light sources, LEDs frequently have a more divergent irradiation characteristic and larger irradiation surfaces. Corresponding optics are used in order to still be able to guide their light towards the illumination field in a directed manner.

So-called TIR lenses (Total Internal Reflection) are known in the state of the art with regard to the efficient projection of the light. A TIR-lens has a geometry which ensures that the incident light is incident at sufficiently flat angles at the side surfaces in order to satisfy the current conditions for total reflection of the lens material. Thereby the light is guided in a manner similar as in a light guide. However, in addition to the mere forwarding of light, the exiting bunch of light has a desired beam shape due to the geometry of the TIR lens and in particular due to its jacket surface. TIR lenses are, for example, produced in an injection-molded process and are assembled to an illumination with an LED light source.

The initially mentioned camera systems are used in a large diversity of variants which differ in the resolution of the image sensor, but also with regard to their viewing fields and their working distance. Having regard to an efficient illumination, a matching TIR lens having a suitable illumination field must respectively be used. Thus, in some applications maximum working distances should be achieved for a given camera viewing field. In contrast to this, a larger overlap region of individual illumination units is rather required having regard to complicated surface properties of the detected objects, such as, the shine or the partial transparency. Thus, a large number of TIR lenses must be held available for the diversity of requirements which causes a corresponding demand in effort and cost for the development, production, storage and administration of the optical components. An adaptation of the illumination field in the field is not possible without an exchange of the illumination module.

The DE 10 2008 014 349 B4 discloses an optical sensor having a transmission optics in whose concentrator a light guidance is achieved by means of total reflection at the jacket surface. From the U.S. 2006/0196944 A1 an illumination apparatus having an LED light source and a lens setting the angular range is known at whose outer jacket surface the light is guided by means of total reflection. The problem of the lacking adaptation possibilities for the arising illumination field is, however, not discussed in the state of the art.

For this reason it is the object of the invention to improve an illumination optics based on a TIR lens or on comparable illumination optics.

This object is satisfied by an illumination apparatus and by a method for the generation of an illumination field in accordance with claim 1 or claim 12 respectively. In this connection the invention starts from the underlying idea of guiding the light of a light source through an illumination optics, in particular through a TIR lens, whose geometry is designed in such a way that light present in the illumination optics through a light entrance region is incident in a sufficiently flat manner from the inside at the jacket surface and is thus forwarded and beam-shaped by means of total reflection prior to being projected in the direction of the illumination field via a light exit surface.

In order to now set optical properties and thereby the light distribution in the illumination field, such as for example, its extent or position, brightness or the divergence of the projected bunch of light, the light guidance region or the TIR lens respectively are at least partly formed from a deformable material. For this reason the light guidance region or the TIR lens respectively can be deformed, preferably reversibly or elastically deformed, through a corresponding exertion of force. Thereby, the geometry of the jacket surface changes in particular its curvature or its angle with respect to a line of sight having regard to the light source and in this way the angle of incidence and the angle of reflection of the guided light. The light distribution of the irradiated light is thus set in dependence on the degree of deformation.

The invention has the advantage that the diversity of variants and thereby the demand in effort and cost in development, production and administration is reduced. Possibilities of setting the optical properties of the illumination apparatus in the field by the customer or the service are created without an exchange of the illumination apparatus.

The material preferably comprises silicone. Silicones have the required properties with respect to deformability and elasticity. Thus, for example, hyper-elastic silicones having a large reversible stretch are available which at the same time are incompressible. The latter means that material displaced by means of the exertion of a force has to completely get out of the way and thereby particularly efficiently changes the geometry of the jacket surface.

The light guidance region preferably comprises a plurality of materials having different elastic properties. In this connection both composite materials, as well as sectionally different materials are plausible which are smooth and strongly deformable up to hard and rigid. In this way it can be predefined as to how the light guidance region reacts to an exertion of force in an improved and more targeted manner, this means how a desired deformation of the geometry of the jacket surface can respectively be achieved. Smoother or better deformable part regions in this connection change their shape faster than harder part regions.

The illumination apparatus preferably has an actuator in order to exert a radial force and/or a vertical force at the light guidance region. A vertical force is preferably introduced indirectly via the light entrance region or the light exit region. This force presses the light entrance region together so that it is shortened and the compressed deformable material escapes outwardly on a corresponding extension of the jacket surface. A radial force acts on the jacket surface which is thereby constricted, straightened or displaced.

At least one section of the jacket surface is preferably shaped as a truncated cone. The jacket surface thus corresponds to a tapered jacket. In this case a vertical force brings about a shortening, this means a reduction of the height of the taper and an increase of the opening angle in the fictitious tip of the cone. Thereby, the angle of the internal total reflection becomes flatter and the illumination field becomes larger. A removal of the pressure brings about a reversed adjustment of the illumination apparatus. A radial force bends the jacket surface so that the truncated cone is constricted or for a complete engagements acts like a vertical force only in a reversal of the roles of compression and removal of the pressure.

At least one section of the jacket surface is preferably formed as a paraboloid. Whereas a cone practically acts like a flat mirror with respect to the light of the light source, a paraboloid at the same time bunches the light like a hollow mirror. Also other shapes, such as ellipsoids, hyperboloids and freeform surfaces are plausible.

The light entrance region preferably has a recess in which the light source is arranged. The light source can thereby practically be inserted into the illumination optics in one piece where the light entrance region then surrounds the light source over a large angular range. Thereby the illumination optics receives the light of the light source over a large angular range of irradiation angles. For this reason, the irradiated light is guided into the illumination region in a directed manner, also for a non-collimated light source having a divergent irradiation characteristics, for example an LED having a large irradiation surface and/or a large angle of irradiation.

The light entrance region is preferably configured at least partly convex. This convex part region more preferably lies in the center. Thereby, an inner part of the light of the light source is beam-shaped, with the light arriving at the light exit region directly without total reflection at the jacket surface.

The light exit region is preferably configured convex. In this way, also the light exit region contributes to the beam shaping. Preferably, the overall light exit region and not only a part region thereof forms a convex contour. Alternatively, also a planar light exit region is plausible. The light exit region can additionally be structured, for example, by means of roughening or by micro-elements, such as micro-lenses which then for example act as a diffusor or a homogenizer. Such additional effects can also be achieved by the consecutive arrangement of corresponding optical elements.

In an advantageous development a camera, in particular a camera-based code reader or a camera for the inspection of objects or for the measurement of objects, comprising an image sensor for the recording of image data, an evaluation unit for the reading of codes or for the determination of object properties on the image data and an illumination apparatus in accordance with the invention is provided. This camera offers the possibility of variably setting the illumination field and in this way adapting it to different requirements and environmental conditions.

The method in accordance with the invention can be furthered in a similar manner and in this connection shows similar advantages. Such advantageous features are described by way of example, but not conclusively in the dependent claims dependent on the independent claims.

The invention will be described in detail also with respect to further features and advantages by way of embodiments and with reference to the submitted drawing.

The images of the drawing show in:

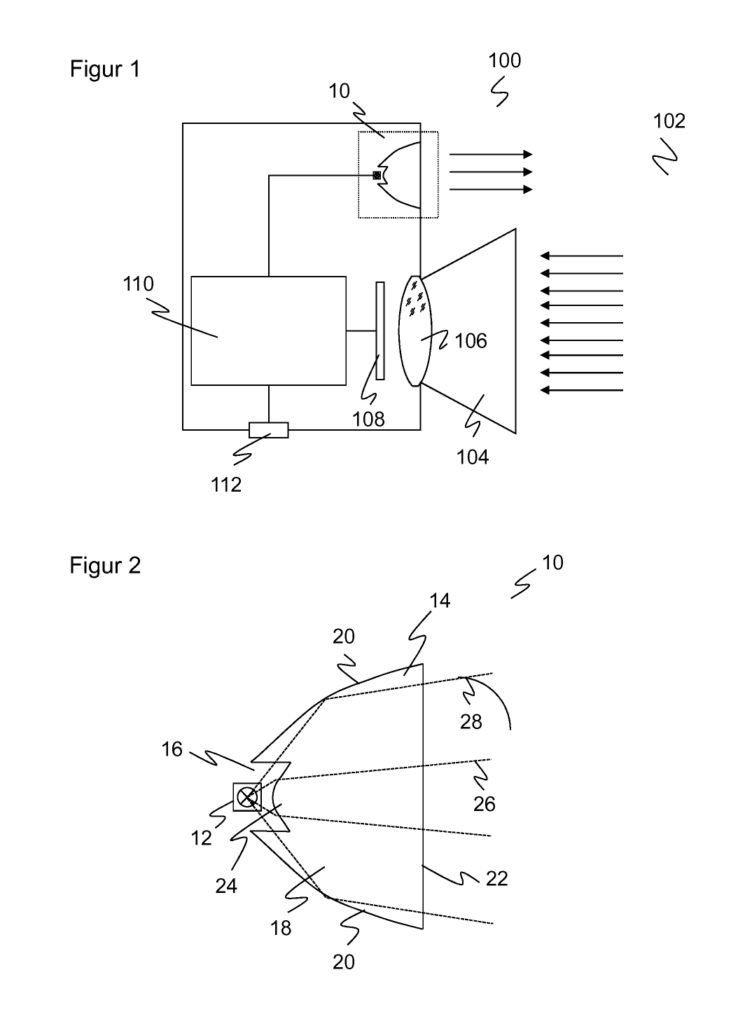

FIG. 1 a schematic sectional illustration of a camera having an illumination apparatus;

FIG. 2 an enlarged schematic sectional illustration of the illumination apparatus having internal total reflection in accordance with FIG. 1;

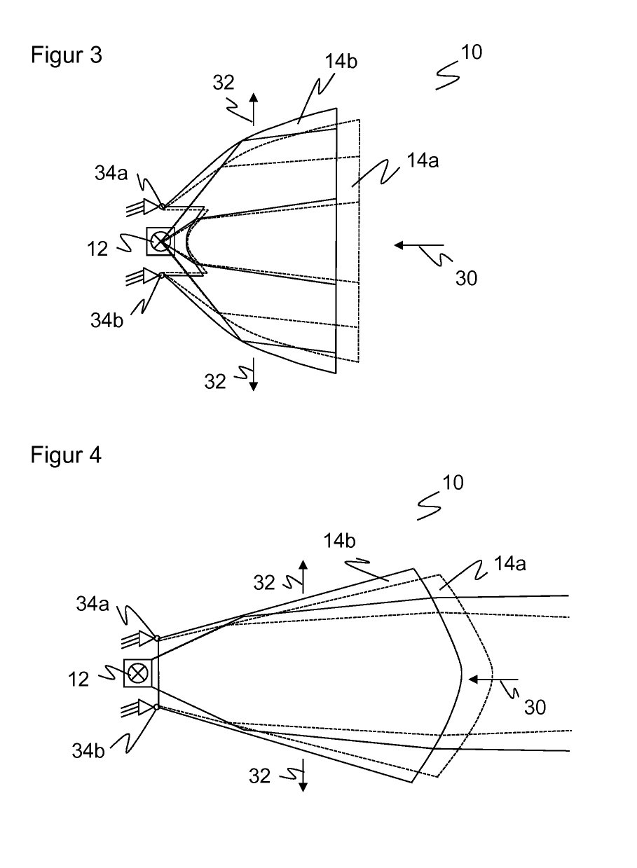

FIG. 3 an embodiment of an illumination apparatus having a deformable light guidance region in the form of a paraboloid; and

FIG. 4 an embodiment of an illumination apparatus having a deformable light guidance region in the shape of a truncated cone.

FIG. 1 shows a schematic sectional illustration of a camera 100. The camera 100 can, for example, be used for the measurement of objects or for the inspection of objects, as well as for the detection of codes and the reading of their contents. The camera 100 is equipped with an illumination apparatus 10 for the illumination of a recording region 102 of the camera 100 whose assembly will be explained in the following in more detail.

The camera 100 detects light from the recording region 102 by means of a recording objective 104 in which only one illustrated lens 106 represents the recording optics. An image sensor 108, for example a CCD chip or a CMOS chip having a plurality of pixel elements arranged to a line or to a matrix, generates image data of the recording region 102 and of the objects and code regions possibly present there and forwards these to an evaluation unit 110. The evaluation unit 110 is implemented at one digital component or at a plurality of digital components, for example, micro-processors, ASICs, FPGAs or the like which can also be provided completely or partly outside of the camera 100 and at the same time controls the illumination apparatus 10.

The image data is processed in the evaluation unit 110, for example is preliminary filtered, smoothed, brightness-normalized, cut to certain regions or binarized. Then structures of interest are recognized and segmented, for example into individual objects, lines or code regions. These structures are measured or are checked with respect to certain properties. In as far as codes should be read these are identified and decoded, this means that the information included in the codes is read out.

Data can be output at an output 112 of the camera 100 and indeed also measurement results, such as read code information or determined dimensions and results of inspection, as well as data in different processing stages, such as raw image data, preprocessed image data, identified objects or not yet decoded code image data.

FIG. 2 shows the settable illumination apparatus 10 in a schematic sectional illustration. A light source 12, for example an LED irradiates light into a comparatively large angular range. An associated illumination optics, illustrated by way of example as a TIR lens 14, serves as a beam guiding and beam shaping element. The TIR lens 14 comprises a light entrance region 16, a light guidance region 18 having a jacket surface 20 and a light exit region 22.

A recess is provided in the light entrance region 16 in the TIR lens 14. Thereby also laterally irradiated light of the light source 12 arrives in the TIR lens 14. The light entrance region 16 is convexly shaped in a central region 24 in order to bunch the inner part 26 of the incident light. In contrast to this, the light exit region 22 is flat in the illustrated embodiment, wherein a structuring can be provided at a comparatively small scale.

The light of the light source 12 thus arrives in the TIR lens 14 in as far as it is only coarsely irradiated in the direction of the illumination optics. Light irradiated backwardly from a practically completely undirected light source 12 can be thrown back into the TIR lens 14 by an additional non-illustrated reflector.

The inner part 26 of the bunch of light which has already been irradiated in the desired direction toward the illumination field in the recording region 102 arrives directly at the light exit surface 22 in the TIR lens 14. In contrast to this, the outer part 28 of the bunch of light is guided at the jacket surface 20 by means of total reflection and thus likewise arrives at the desired illumination field.

Light source 12 and TIR lens 14, as well as their geometry predefine the illumination field and the light distribution within the illumination field. In order to arrive at a different illumination field or at a different light distribution respectively, the light guidance region 18 is now deformed in accordance with the invention. Thereby, the illumination apparatus 10 can be set without having to exchange it. Practically, a deformation of the light guidance region 18 preferably means a deformation of the illumination optics of the TIR lens 14 itself respectively.

FIG. 3 shows an embodiment of an illumination apparatus 10 having an elastic or partly elastic TIR lens 14a-b. For reasons of improved clarity reference numerals for the different regions of the TIR lens 14a-b have been omitted from FIG. 3. The TIR lens 14a is illustrated including beam guidance in a non-deformed state by means of dotted lines and the TIR lens 14b including the beam guidance is illustrated in a deformed state by means of continuous lines. As can directly be recognized the deformation of the TIR lens 14a-b ensures a corresponding change of the optical properties and thus of the irradiated light, in particular an expansion or a constriction of the irradiation angle of the illumination apparatus 10 and in this way of the illumination field generated therefrom.

For example, silicone is used as an elastic material for the TIR lens 14a-b. This preferably has hyper-elastic material properties, such as a large reversible extent and incompressibility. Also a plurality of materials can be used in order to bring about targeted changes of shape which lead to a desired contour of the jacket surface 20 in dependence on the degree of deformation. In this connection, the use of differently hard silicones and/or polymers without hyper-elastic properties can be combined in a sensible manner.

The deformation is achieved by means of external introductions of force. This can be achieved by means of arbitrary known actors, for example, by means of a manual screw mechanism, as well as by electromagnetic or pieco-electric drives and by artificial muscles. A vertical force at the light exit surface, as indicated by the arrow 30, brings about shortening of the TIR lens 14a-b. The material must escape and effectively a radial force acts thereby, as indicated by the further arrows 32, which widens the jacket surface 20. It is likewise plausible to apply the radial force from the outside and in this way to in particular engage at certain sections of the jacket surface in a targeted manner. In the shown embodiment the TIR lens 14a-b is fixed at its entrance region at a storage 34a-b. This is only one example of how the counter force with respect to the force acting from the outside can be applied at an arbitrary different position, such that the TIR lens 14a-b is actually deformed and does not simply get out of the way. In this connection it can be important to combine the deformation with a displacement or a shear in order to set the position of the illumination field.

FIG. 4 shows a further embodiment of an illumination apparatus 10 having a deformable TIR lens 14a-b. The illustration with dotted lines corresponds to a non-deformed state and that with continuous lines to a deformed state of the FIG. 4. Again reference numerals for the different regions of the TIR lens 14a-b have been omitted for reasons of improved clarity.

The TIR lens 14a-b in accordance with FIG. 4 differs from FIG. 3 in that the jacket surface 20 has the geometry of a truncated cone rather than that of a paraboloid in this instance. Thereby, the light is mirrored once during the total reflection in the light guidance region 18 and is no longer bunched at the same time in accordance with a kind of a hollow mirror. Moreover, the light exit surface 22 is configured convex and not planar in FIG. 4. Thereby, an additional bunching of the beam is achieved. Mixed shapes such as a truncated cone having a planar light exit surface 22 or a paraboloid with convex light exit surface 22 are plausible and are only examples of the numerous possible geometries. Further examples are ellipsoids, hyperboloids or pyramid cones, as well as freeforms, in particular having section-wise contours of different behaviors of curvature, including straight sections.

1. An illumination apparatus for the generation of an illumination field for an optoelectronic sensor which has at least one light source and one illumination optics in order to guide light of the light source into the illumination field in a directed manner, wherein the illumination optics has a light entrance region, a light guidance region having a jacket surface and a light exit region such that the light of the light source is guided from the light entrance region to the light exit region in the illumination optics by means of total reflection at the jacket surface,
wherein the light guidance region is at least partly formed from a deformable material in such a way that the geometry of the jacket surface can be changed by exerting a force at the light guidance region.

2. The illumination apparatus in accordance with claim 1,
wherein the one illumination optics further comprises a TIR lens.

3. The illumination apparatus in accordance with claim 1,
wherein the material comprises silicone.

4. The illumination apparatus in accordance with claim 1,
wherein the light guidance region comprises a plurality of materials having different elastic properties.

5. The illumination apparatus in accordance with claim 1,
further comprising an actuator in order to exert a radial force and/or a vertical force at the light guidance region.

6. The illumination apparatus in accordance with claim 1,
wherein at least one section of the jacket surface is configured as a truncated cone.

7. The illumination apparatus in accordance with claim 1,
wherein at least one section of the jacket surface is configured as a paraboloid.

8. The illumination apparatus in accordance with claim 1,
wherein the light entrance region has a recess in which the light source is arranged.

9. The illumination apparatus in accordance with claim 1,
wherein the light entrance region and/or the light exit region is/are configured at least partly convex.

10. A camera, comprising an image sensor for the recording of image data, an evaluation unit for the reading of codes or for the determination of object properties from the image data and an illumination apparatus , the illumination apparatus comprising at least one light source and one illumination optics in order to guide light of the light source into the illumination field in a directed manner, wherein the illumination optics has a light entrance region, a light guidance region having a jacket surface and a light exit region such that the light of the light source is guided from the light entrance region to the light exit region in the illumination optics by means of total reflection at the jacket surface, wherein the light guidance region is at least partly formed from a deformable material in such a way that the geometry of the jacket surface can be changed by exerting a force at the light guidance region.

11. The camera in accordance with claim 10,
wherein the camera is one of a camera based code reader, and a camera for the inspection of objects or for the measurement of objects.

12. A method for the adaptation of illumination properties of an illumination apparatus for an optoelectronic sensor, wherein the light of a light source is guided in an illumination optics from a light entrance region to a light exit region by means of total reflection at a jacket surface of a light guidance region,
wherein a force is exerted at the light guidance region formed at least partly from a deformable material and thereby a change of the geometry of the jacket surface is brought about.

13. The method in accordance with claim 12,
wherein the illumination optics has a TIR lens.
